(19) United States
(12) Patent Application Publication
(10) Pub. No.: US 2023/0090540 A1
(43) Pub. Date: Mar. 23, 2023

(54) CLAMPING DEVICE FOR A TOOL OR WORKPIECE, DRAW-IN COLLET AND COUPLING ELEMENT FOR THE CLAMPING DEVICE, AND METHOD FOR PREPARING THE CLAMPING DEVICE

(71) Applicant: Haimer GmbH, Igenhausen (DE)

(72) Inventor: Franz-Josef Haimer, Hollenbach-Igenhausen (DE)

(21) Appl. No.: 17/951,603

(22) Filed: Sep. 23, 2022

(30) Foreign Application Priority Data
Sep. 23, 2021 (DE) 10 2021 124 718.7

(51) Int. Cl. B23B 31/26; B23B 31/20

(52) U.S. Cl. CPC B23B 31/265; B23B 31/20; B23B 31/268; B23B 2260/03; B23B 2260/042

(57) ABSTRACT

A clamping device for a tool or workpiece has a draw-in collet and a coupling element. The clamping device has first and second bayonet closures with which the draw-in collet can be locked and braced against the coupling element. The first and second bayonet closures are brought into engagement at the same time, as a result of which the draw-in collet is locked against the coupling element using the first bayonet closure, and the draw-in collet is braced against the coupling element using the second bayonet closure. First, the draw-in collet is pushed into the coupling element with partial actuation of the bayonet closures. Then the draw-in collet is rotated relative to the coupling element with a further partial actuation of the bayonet closures, and finally the draw-in collet is withdrawn to thereby lock the first bayonet closure and to brace the second bayonet closure.

### CROSS-REFERENCE TO RELATED APPLICATION

This application claims the priority, under 35 U.S.C. § 119, of German Patent Application DE 10 2021 124 718.7, filed Sep. 23, 2021; the prior application is herewith incorporated by reference in its entirety.

### FIELD AND BACKGROUND OF THE INVENTION

The invention relates to a clamping device for a tool or workpiece, having a draw-in collet and a coupling element, to a draw-in collet for a clamping device, to a coupling element for a clamping device, and to a method for preparing a clamping device for a tool or workpiece, having a draw-in collet and a coupling element.

Retaining rotary tools, such as drills, but in particular milling tools, interchangeably in a clamping device of a machine tool is known.

In this respect, the clamping device comprises a substantially sleeve-shaped collet with a cylindrical inner casing and a substantially conical outer casing—in short also referred to as outer cone —, which is or has been inserted with its tapered end at the front into a likewise conical receiving opening/bore—in short also referred to as inner cone —, which is central with respect to the axis of rotation, of a main body of the clamping device. The tool, or a cylindrical shank of the tool, is clamped in the cylindrical inner casing of the collet.

The collet is usually divided into a multiplicity of tongues by a multiplicity of circumferentially distributed, axial slots, which penetrate the collet radially. The slots are closed only at one of their longitudinal ends and are open toward the end edge of the collet at their other longitudinal end.

When the outer cone of the—slotted—collet is pressed into the inner cone of the main body, the tool, which is inserted with its cylindrical shank in the collet, or received with its cylindrical shank in the cylindrical inner casing of the collet, is radially clamped/gripped in the process.

Reference is made to a draw-in collet if the collet is pressed into the main body by means of a mechanism or tension system—of any kind whatsoever.

Such a clamping device for a tool, having a draw-in collet, is described, for example, in our earlier German published patent application DE 44 05 242 A1.

In that clamping device, the drawing-in system is realized using a coupling element, here referred to as coupling piece, which is provided on its side axially facing the collet with an internal thread for receiving a threaded head of the draw-in collet, and at its other end with an external thread—formed in the opposite direction to the internal thread. In a similar way to a screw drive, the draw-in collet is drawn into the receiving opening of the main body by rotating the coupling element—, with an inside diameter of the cylindrical inner casing of the draw-in collet becoming smaller and a shank of the tool being secured in the cylindrical inner casing of the draw-in collet in a radial press fit.

A further such clamping device for a tool, having such a draw-in collet and a coupling element—in this case of a different kind—is described in published European patent application EP 0 007 887 A1.

In that case, the coupling element—designed in a different way—is coupled to the draw-in collet by means of a bayonet closure that is located on the coupling element and on the draw-in collet.

The coupling element is in the form of a sleeve, at the end facing the draw-in collet of which there are provided—on the inside, or on its inner circumference—longitudinal grooves that start (on the end face) and at the (longitudinal-groove-) end of which there are provided adjoining transverse grooves. An internal thread for attachment to a tension rod is provided—likewise on the inside—at the other end of the coupling element.

At its end facing the coupling element, the draw-in collet provides closure elements that are located on the outside or on its outer circumference and are in the form of radial protrusions with inclined closure surfaces.

The bayonet closure is closed—and thus the draw-in collet and coupling element are coupled—by pushing the closure elements of the draw-in collet into the grooves of the coupling element and rotating them there.

In modern machine tools, the tools rotate at an extremely high speed. In this respect, very high requirements are placed on the precision of concentricity of the tool. Eccentricity errors and angular errors of the axis of rotation of the tool shorten the service life of the tool, since the cutting edges of the tool are subjected to uneven loading in the event of concentricity errors. They also adversely affect the machining quality. In addition, setup times are critical.

### SUMMARY OF THE INVENTION

It is accordingly an object of the invention to provide a clamping device and a setup method which overcome the above-mentioned disadvantages of the heretofore-known devices and methods of this general type and which provides for secure and precise clamping of a tool or a workpiece and also for a quick and efficient set up the device.

With the above and other objects in view there is provided, in accordance with the invention, a clamping device for a tool or workpiece, the clamping device comprising:
a draw-in collet and a coupling element;
a first bayonet closure and a second bayonet closure for locking and bracing said draw-in collet against said coupling element;
said first and second bayonet closures being configured to be brought into engagement at the same time, with said draw-in collet being locked against said coupling element by way of said first bayonet closure, and said draw-in collet being braced against said coupling element by way of said second bayonet closure.

The objects of the invention are achieved by a clamping device for a tool or workpiece, having a draw-in collet and a coupling element, by a draw-in collet for such a clamping device, by a coupling element for such a clamping device, and by a method for preparing such a clamping device.

Terms used where required, like top, bottom, front, rear, left or right, and inner or outer, are—unless explicitly defined otherwise—to be understood as per conventional understanding. Terms like radial and axial, where used and unless explicitly defined otherwise, are to be understood in relation to center axes, or axes of symmetry, or axes of rotation of components/component parts described here.

The expression “substantially” as used herein should be understood to mean “to a practically still significant degree.” Possible deviations from exactness that are thus implied by this concept may arise unintentionally (that is to say without any functional basis) owing to manufacturing or assembly tolerances or the like.

The clamping device for a tool or workpiece, having a draw-in collet and a coupling element, provides a first and a second bayonet closure, by which the draw-in collet can be locked and braced against the coupling element.

In the process, the first and the second bayonet closure can be brought into engagement at the same time.

That is to say, in descriptive terms, the first and the second bayonet closure, or their closure elements, are located and formed in such a way that first and second are actuatable (only) at the same time.

The draw-in collet can be locked against the coupling element, or the draw-in collet is locked against the coupling element, using the first bayonet closure; the draw-in collet can be braced against the coupling element, or the draw-in collet is braced against the coupling element, using the second bayonet closure.

In accordance with the method for preparing a clamping device for a tool or workpiece, having a draw-in collet and a coupling element, it is provided that the draw-in collet is axially displaced relative to the coupling element by applying an external force counter to an internal force, in particular is pushed into the coupling element by applying an external force to the draw-in collet, at the same time a first bayonet closure and a second bayonet closure being partially actuated.

Then, the draw-in collet, under the external force, is rotated relative to the coupling element into a predefined position, in particular into a stop in the first bayonet closure, for example by approximately 60°, at the same time the first bayonet closure and the second bayonet closure still being partially actuated.

Then, the external force, in particular the external force on the draw-in collet, is withdrawn, the first bayonet closure being locked and the second bayonet closure being braced.

If the clamping device is then in the state in which the first bayonet closure is locked and the second bayonet closure is braced, it is possible here in particular for the first bayonet closure to be positioned free of axial force. The second bayonet closure may be subjected to loading by axial force.

In this respect, the term “locked” may be understood to mean a state in which at least complete detachment of two connected parts—connected by means of the bayonet closure—from one another is prevented. Here—for example−, it may be understood to mean that the draw-in collet and the coupling element—without being unlocked—do not “fall one out of the other”. In the “locked position”, further relative movements of the two connected parts—connected by means of the bayonet closure—may also be prevented, for example (further) and/or (reverse) rotation of the two connected parts—connected by means of the bayonet closure—with respect to one another. Bayonet closure elements that are suitable for this may be undercuts.

The term “braced” can be understood to mean that closure elements of the bayonet closure of the two parts connected by means of the bayonet closure are connected to one another or can be connected to one another by a force fit, through which connection a force flow is then conducted (cf. above: “subjected to loading by axial force”).

When—in descriptive terms for the clamping device—the second bayonet closure is then braced or subjected to loading by axial force—and the first bayonet closure is locked and in the process positioned free of axial force, the (axial) tensile force resulting in the tool or workpiece being clamped in place can be conducted to the draw-in collet solely or only via the second bayonet closure. The first bayonet closure—by virtue of not being subject to load—still remains free of axial force.

It has thus proven advantageous, in particular in the case of the invention, that the use of two bayonet closures, in particular when actuated at the same time, to enable quicker setup times (or changeover times (of the draw-in collets)). The draw-in collet—solely by means of a bayonet closure movement (instead of a protracted and complex screwing procedure)—can quickly and easily be connected to or detached from the coupling element. Nothing needs to be detached or disassembled from a main body receiving the collet.

When the draw-in collet is being removed, it is merely necessary, by means of an insertion aid, to press it in axially—(deeper and) counter to the bracing effected by the second bayonet closure—(, in order to release the locking of the first bayonet closure), then to rotate it—and then continue to axially “take it out” again, this being possible only without a component for safety purposes. A new draw-in collet is inserted in reverse order and in accordance with the method.

The invention also makes it possible to realize compact clamping devices which are furthermore also distinguished by high rigidity and low sensitivity to dirt.

The use of two bayonet closures can furthermore in particular also result in it being possible to realize more force-transferring surfaces, for example on clamping shoulders in the form of bayonet closure elements.

Furthermore—if the locking is separated from the force transmission, as is done here by the two bayonet closures—it becomes possible to introduce tensile/clamping forces in a highly accurate and defined manner as a result.

The clamping device according to the invention can be used on many conventional machines with drawing-in clamping means. On account of the short structure, use as a vise system is likewise possible.

The collet—for a clamping device for a tool or workpiece, having a draw-in collet and a coupling element—provides a draw-in-collet-side bayonet closure element of a first bayonet closure and a draw-in-collet-side bayonet closure element of a second bayonet closure.

The draw-in-collet-side bayonet closure element of the first bayonet closure is a locking stop, for example in the form of a transverse groove that is closed at its one end and in particular has an undercut.

The draw-in-collet-side bayonet closure element of the second bayonet closure is a draw-in-collet-side, force-transferring clamping shoulder that can be braced against a coupling-element-side, force-transferring clamping shoulder. In particular, a clamping surface which—when force is being transferred or in the event of a force fit—bears against a (mating) clamping surface, may be provided on the clamping shoulder. Expediently, here the clamping surface and (mating) clamping surface can completely overlap.

The coupling element (in particular in the form of a complementary mating piece to the draw-in collet)—for a or the clamping device for a tool or workpiece, having a draw-in collet and a coupling element—provides a coupling-element-side bayonet closure element of a first bayonet closure and a coupling-element-side bayonet closure element of a second bayonet closure.

The coupling-element-side bayonet closure element of the first bayonet closure is a locking element, for example a (locking/latching) pin, which is suitable in particular to be received in the locking stop or in the transverse groove.

The coupling-element-side bayonet closure element of the second bayonet closure is a coupling-element-side, force-transferring clamping shoulder (, in particular also having the clamping surface—see above,) that can be braced against a draw-in-collet-side, force-transferring clamping shoulder.

Thus, it has proven particularly advantageous here in the case of the invention that in particular finely machined clamping shoulders, or their clamping surfaces, with precise axial running ensure extremely high precision of concentricity. In this respect, it has proven to be extremely expedient when the clamping surfaces—that can be placed against one another—of the mutually braceable clamping shoulders lie in a plane perpendicularly in relation to a center axis of the clamping device or draw-in collet or coupling element. The alignment of the clamping surfaces perpendicularly in relation to the center axis makes it possible to have the effect that no radial forces arise at the point of contact of the clamping surfaces placed against one another—and thus the draw-in collet can be aligned in a self-centering manner when it is being drawn into the main body. High concentricity can be ensured.

The bayonet closures—in particular with the clamping shoulders—thus also ensure a quick and secure setup. Significant advantages result, specifically with regard to manufacturing smaller batch sizes.

The high precision (of concentricity) realized means it is no longer necessary to set up the concentricity in the clamping device; this also results in a saving on time.

The coupling element is preferably a tension sleeve, i.e. in particular is sleeve-shaped. In this respect, such an element can be secured, for example screwed, to a tension rod, or formed in one piece with a tension rod. As an alternative, it can also be provided that the coupling element is the tension rod itself or part thereof.

In the case of the clamping device, it is furthermore also possible to provide a clamping or drawing-in system, in particular a hydraulically and/or pneumatically acting or electromechanically actuated clamping or drawing-in system, which can continuously adjust a force.

By using such a clamping or drawing-in system,—via the coupling element—connected to the draw-in collet—the draw-in collet can then be axially displaced (by an axial tensile force), i.e. can be drawn into a main body, for example.

It may thus also be expedient when a tension rod is provided which can be connected or is connected, for example can be screwed or is screwed, to the coupling element, on the one hand, and can be connected or is connected to the clamping or drawing-in system, on the other hand.

As a development, it has also proven to be expedient to provide a main body having an inner cone, in which the draw-in collet having an outer cone can be received.

To that end, then, as another development, in the case of the main body a concentricity adjusting device may be provided, for example concentricity screws—by means of which it is possible to radially position the main body, or part of the main body.

It has also proven to be expedient when a cone angle of the inner and/or the outer cone is between 1° and 10°, in particular between 2° and 3°, very preferably approximately 2°30′. Such a small adjustment angle—in comparison with conventional, larger adjustment angles—makes it possible to realize a larger clamping force, thereby producing considerably greater rigidity given longer projecting lengths. In addition, this ensures good self-locking in the event of damage.

It is in particular also expedient when the draw-in collet—having slots—in addition has spreading elements, which spread open the draw-in collet, when it is detached, from a non-spread state, in particular by a maximum radial widening distance of approximately 0.1 mm.

In this respect, it has also proven to be expedient when provision is made that the cone angle of the outer cone of the draw-in collet in the non-spread state corresponds to the cone angle of the inner cone of the main body, and/or the contour of the outer cone of the draw-in collet lies on an imaginary right circular cone.

That is to say, the spreading elements ensure that the draw-in collet, manufactured in the nominal diameter of the tool/workpiece to be clamped in place, in the detached state is widened by approximately 0.1 mm, with the result that a more secure automatic changeover of parts is ensured.

It is also expedient when the spreading elements are elastomer fillings, in particular elastomer fillings in the slots and/or in bores through which the slots pass. This can also prevent soiling of the clamping device. These bores, expediently (corresponding to the slots) starting at the tool-/workpiece-side end face of the draw-in collet,—if they are not quite filled as far as the tool-/workpiece-side end face of the draw-in collet—may then also be used to apply the insertion aids.

According to one refinement, it is also possible to provide that the second bayonet closure has mutually clampable, coupling-element-side and/or draw-in-collet-side clamping shoulders, in particular multiple, very particularly three, clamping shoulders distributed evenly over a circumference, in particular inner circumference, of the coupling element and/or multiple, very particularly three, clamping shoulders distributed evenly over a circumference, in particular outer circumference, of the draw-in collet.

The clamping force—for clamping the tool or workpiece—can thus be conducted over the clamping shoulder/shoulders in the case of the clamping device.

Furthermore, it may then also be expedient when clamping surfaces that can be placed against one another of the mutually braceable clamping shoulders of the second bayonet closure lie in a plane perpendicularly in relation to a center axis of the clamping device, with it preferably then also furthermore being the case that the clamping surfaces that can be placed against one another of the mutually braceable clamping shoulders of the second bayonet closure are formed and located on the second bayonet closure in such a way that, when the first bayonet closure is in the locked position, the clamping surfaces that can be placed against one another substantially completely overlap.

The alignment of the clamping surfaces perpendicularly in relation to the center axis makes it possible to have the effect that no radial forces arise at the point of contact of the clamping surfaces placed against one another—and thus the draw-in collet can be aligned in a self-centering manner when it is being drawn into the main body. High concentricity can be ensured as a result.

It may also be provided that the first bayonet closure, on the coupling-element side, has multiple, in particular three locking elements distributed evenly over a circumference, for example (latching/locking) pins, and/or, on the draw-in-collet side, has multiple, in particular three locking stops distributed evenly over a circumference, each of which for example is in the form of a transverse groove which is closed at its one end and in particular has an undercut.

It is also expedient when a clamping mechanism is provided, which acts on the draw-in collet and thus can bring about the bracing of the second bayonet closure, or of its clamping shoulders/clamping surfaces against one another. Said clamping mechanism may preferably be realized in the form of a spring-loadable or spring-loaded pressing ring, which can be placed against or can act on that end of the draw-in collet that is opposite the tool-/workpiece-side end face of the draw-in collet.

This spring may thus also bring about the internal force counter to which the draw-in collet is axially displaced by applying the external force—and which maintains the bracing of the second bayonet closure when the external force is withdrawn.

In particular, it is also expedient when a force flow of a clamping/tensile force, which axially draws in the draw-in collet, is guided over a flexurally elastic region, which is formed in particular on the other side of the receiving region for the tool or the workpiece of the draw-in collet downstream of the second bayonet closure, but close to the second bayonet closure, for example on the tension rod.

Here, it is then also possible to provide that the flexurally elastic region has a bellows-like, in particular corrugated-bellows-like form, and/or is formed in/on the tension rod.

This flexurally elastic region—for example on the tension rod—in particular ensures that the (axial) tensile forces (when a tool or workpiece is being clamped) are distributed evenly over the clamping surfaces or clamping shoulders (of the second bayonet closure)—and thus can also ensure that the draw-in collet is drawn in in a self-centered manner.

Furthermore, it is also possible to provide at least one longitudinal groove, which may form a common, draw-in-collet-side bayonet closure element of the first and the second bayonet closure.

It has also proven to be expedient when the locking stop has an end stop in the case of a transverse groove, having an undercut, on the draw-in collet.

As another development, it is also possible to provide that the coupling element is a tension sleeve, in particular a tension sleeve that can be secured to a tension rod or is formed in one piece with a tension rod, in particular a tension sleeve with coupling-element-side bayonet closure elements of the first and/or the second bayonet closure that are located on the inside of the tension sleeve.

The coupling element may also be a tension rod, in particular a tension rod with coupling-element-side bayonet closure elements of the first and/or the second bayonet closure that are located on the outside of the tension rod.

It may preferably also be provided that the draw-in-collet-side bayonet closure elements of the first and/or the second bayonet closure are located on an internal circumferential surface of the draw-in collet or on an external circumferential surface of the draw-in collet.

It may furthermore be expedient when the draw-in collet provides a receiving opening, in particular a cylindrical receiving opening, for receiving a tool or workpiece to be clamped, in particular a cylindrical workpiece or a tool having a cylindrical shank.

It has also proven to be expedient when the draw-in collet provides a shoulder or the like, which—when the draw-in collet is drawn into the main body —butts against a complementary stop or shoulder on the main body there. That is to say, the maximum extent to which axial drawing-in can occur is delimited, this delimitation being able to prevent damage to the draw-in collet in particular if it is drawn in empty (i.e. without a tool/workpiece).

The description given so far of advantageous configurations of the invention includes numerous features that are reproduced in the individual dependent claims, in some cases together. However, these features may expediently also be considered individually and combined into appropriate further combinations.

Even though some terms are used in each case in the singular or in combination with a numeral in the description and/or in the patent claims, the scope of the invention is not intended to be limited to the singular or the respective numeral for these terms. Furthermore, the words “a” or “an” should not be understood as numerals, but as indefinite articles.

The properties, features and advantages of the invention that are described above and the manner in which they are achieved will become clearer and more clearly understandable in conjunction with the following description of the exemplary embodiments of the invention, which are explained in greater detail in conjunction with the drawing(s)/figure(s) (identical components/component parts and functions have the same reference signs in the drawings/figures).

Other features which are considered as characteristic for the invention are set forth in the appended claims.

Although the invention is illustrated and described herein as embodied in clamping device for a tool or workpiece, having a draw-in collet and a coupling element, draw-in collet for a clamping device, coupling element for a clamping device, and method for preparing a clamping device for a tool or workpiece, having a draw-in collet and a coupling element, it is nevertheless not intended to be limited to the details shown, since various modifications and structural changes may be made therein without departing from the spirit of the invention and within the scope and range of equivalents of the claims. It should be understood that it is also possible for suitable features of each exemplary embodiment to be considered explicitly in isolation, removed from one exemplary embodiment, introduced into another exemplary embodiment in order to supplement the latter and/or combined with any one of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1A is a longitudinal section, taken along the line E-E in FIG. 1B, through an exemplary embodiment according to the invention of a clamping device for a tool or workpiece, having a draw-in collet and a coupling element;

FIG. 1B is an end view of the clamping device;

FIG. 2 is a detail view of a longitudinal section of a further exemplary embodiment of the invention with the clamping device for a tool or workpiece, having a draw-in collet and a coupling element; and

FIG. 3A is a sectional view of an exemplary draw-in collet according to the invention, taken along the line CC in FIG. 3C;

FIG. 3B is a further sectional view;

FIG. 3C is a detail view of a longitudinal section through the draw-in collet; and

FIG. 3D is a perspective view thereto.

### DETAILED DESCRIPTION OF THE INVENTION

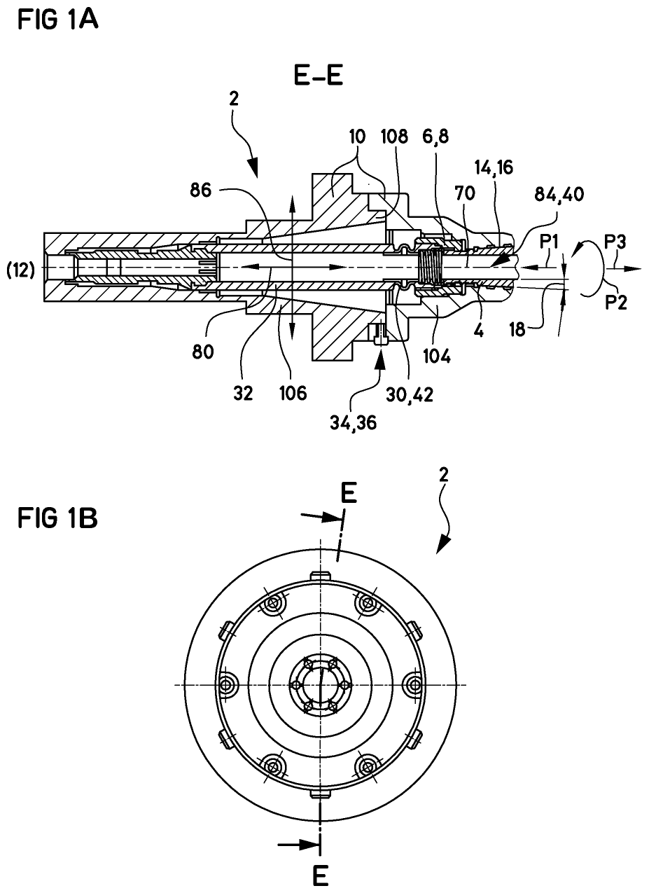

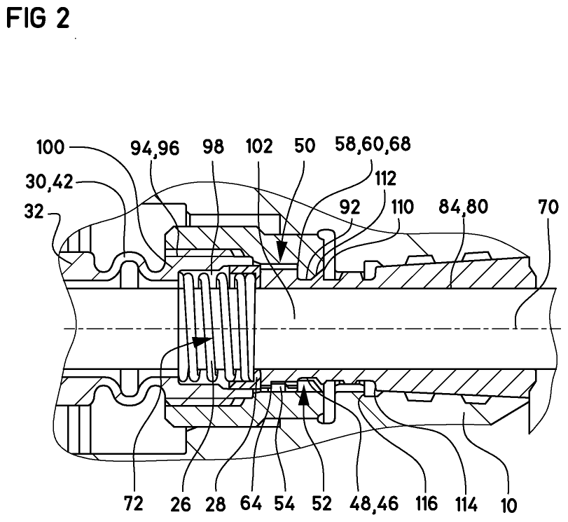

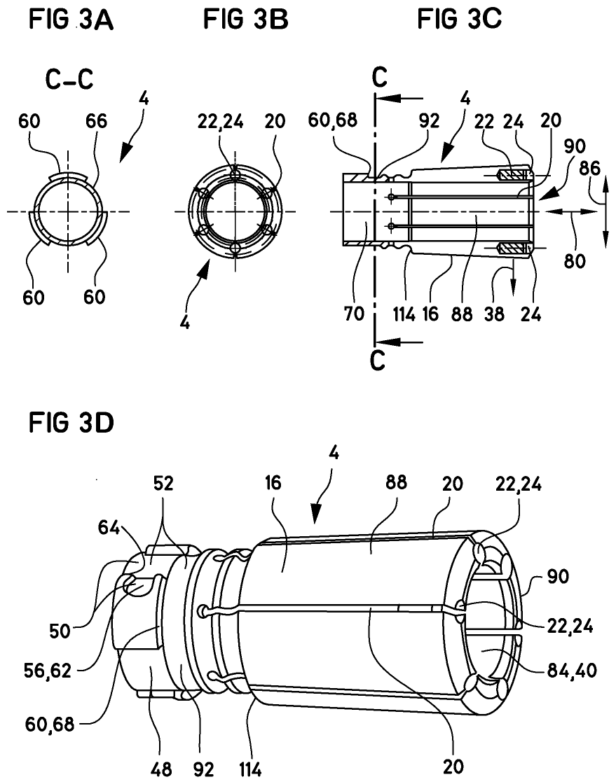

Referring now to the figures of the drawing, which illustrate a (precision) clamping device with a draw-in collet and a coupling element with double bayonet, for tools or workpieces. FIGS. 1A and 1B a clamping device 2 for clamping a tool (or a workpiece). FIG. 2 shows a view of a detail of this clamping device 2, which in particular shows a draw-in collet 4 and a coupling element 6 of the clamping device 2 in more detail. The draw-in collet 4 is then also shown in the several views of FIG. 3, i.e., FIGS. 3A, 3B, 3C, and 3D.

The clamping device 2—a drawing-in clamping system—provides, as depicted in FIG. 1, a substantially sleeve-shaped draw-in collet 4 (cf. FIG. 3) with a cylindrical inner casing 84 and a substantially conical outer casing 16—in short also referred to as outer cone 16 —, which is or has been inserted with its tapered end at the front into a likewise conical receiving opening/bore 14—in short also referred to as inner cone 14 —, which is central with respect to the axis of rotation/center axis 70, of a main body 10 of the clamping device (cf. also FIG. 2).

A tool, or a cylindrical shank of the tool, is clamped (this is not shown) in the cylindrical inner casing (receiving opening) 84 of the draw-in collet 4.

As FIG. 2 in particular also shows, to the draw-in collet 4 there is connected a coupling element 6—in the form of a (sleeve-shaped) tension sleeve 8—which itself in turn is connected, here screwed, to a tension rod 32, on which a clamping/drawing-in system (12) (which is not shown in more detail, and is for example hydraulic) for clamping the clamping device or for gripping the tool (in the receiving opening) acts. For this purpose, at the end facing away from the tool side, the tension rod 32 provides a bore which has an internal thread and via which the clamping/drawing-in system (12) can be screwed to the tension rod 32.

The draw-in collet 4, coupling element 6 or tension sleeve 8, and the tension rod 32 are located in the main body 10, as shown in FIG. 1.

A illustrated by FIG. 2, the connection between the draw-in collet 4 and the coupling element 6 or the tension sleeve 8 is critical. The connection is realized by means of two bayonet closures 50, 52 (in short also referred to just as bayonet)—which are described in more detail below.

Bayonet closure elements (described in more detail below) of the two bayonets (50, 52) or of the first bayonet 50 and the second bayonet 52 are thus on the draw-in collet 4 (here on the outside 48, or on the outer circumference 48) and the coupling element 6 or the tension sleeve 8 (here on the inside 46, or on the inner circumference 46).

The connection between draw-in collet 4 and coupling element 6 is locked using the first bayonet 50; the connection between draw-in collet 4 and coupling element 6 is braced using the second bayonet 52.

Draw-In Collet

As FIG. 3 shows, a multiplicity (here six) of circumferentially evenly distributed axial slots 20, which radially 86 penetrate the draw-in collet 4, divides the draw-in collet 4 into a multiplicity (here correspondingly six) of tongues 88. The slots 20 are closed only at one of their longitudinal ends and are open —toward the end face/edge 90, that faces the tool, of the draw-in collet 4—at their other longitudinal end, as a result of which the draw-in collet 4 can be spread open.

As in particular FIG. 3 also shows, the draw-in collet 4 further also provides a multiplicity of (which here corresponds to the number of slots 20) (thus, here correspondingly also six) circumferentially evenly distributed axial 80 (blind) bores 24, which—like the slots 20—also are closed only at one longitudinal end and are open—toward the end face/edge 90, that faces the tool, of the draw-in collet 4—at their other longitudinal end.

The bores 24 are located in the draw-in collet 4 such that the slots 20 pass through them.

The cone angle 18 of the outer cone 16 of the draw-in collet 4, in the non-spread state, corresponds to the cone angle 18 of the inner cone 14 of the main body 10—and allows for approximately 2°30′ here.

If thus—when the tool is being clamped—the outer cone 16 of the—slotted-draw-in collet 4 is drawn into the inner cone 14 of the main body 10 by means of the clamping/drawing-in system (12), the tool, which is inserted with its cylindrical shank in the draw-in collet 4, or received with its cylindrical shank in the cylindrical inner casing 84 of the draw-in collet 4, is radially 86 clamped/gripped in the process. In this respect, the diameter of the receiving opening 84 of the draw-in collet 4 is dimensioned such that, in the clamped state, it corresponds to the outer diameter of the tool/workpiece that is clamped in place and/or the outer casing 16 of the draw-in collet 4 is in surface contact with the inner cone 14 of the main body 10.

The axial 80 extent of the bores 24 is, as FIG. 3 shows, shorter than that of the slots 20, here for example approximately one quarter of the slot length.

The bores 24 are filled with an elastomer 22—starting from the bore base, not quite as far as the end face/edge 90 of the draw-in collet 4—in such a way that the draw-in collet 4—on account of the slots 20 passing through the bores 24—is widened. That is to say, in cross section more elastomer 22 is filled in the bores 24 than the bore diameter can accommodate in the non-spread state.

In descriptive terms,—as a result of the elastomer 22 —, spreading elements 22 are thus formed on the draw-in collet 4 in the bores 24 or by way of the bores 24 filled with elastomer 22, which spreading elements spread open the draw-in collet 4, when it is detached, from the non-spread state (here by way of example) by a maximum radial 86 widening distance 38 of approximately 0.1 mm.

That is to say, the spreading elements 22 ensure that the draw-in collet 4, manufactured in the nominal diameter of the tool/workpiece to be clamped in place, in the detached state is widened by approximately 0.1 mm —, with the result that a more secure automatic changeover of parts is ensured.

The bores 24 filled with elastomer 22 thus also ensure protection against soiling, and they also—if they are not filled up to the end face/edge 90 —form lugs for an assembly spanner (insertion aid—not shown) for assembling/exchanging/inserting the draw-in collet 4.

As FIG. 3 in particular shows, the bayonet closure elements of the first and the second bayonet 50, 52 are located at that end of the draw-in collet 4 that is opposite the receiving opening 84 or receiving region 40 for the tool —specifically on the outer circumference 48 there.

As depicted in FIGS. 2 and 3, complementary coupling-element-side or tension-sleeve-side bayonet closure elements of the first and the second bayonet 50, 52 are located on the inner circumference 46 of the coupling element 6 or of the tension sleeve 8, with the result that they can be brought into engagement when the draw-in collet 4 is pushed into the (sleeve-shaped) coupling element 6 or tension sleeve 8—and the first bayonet 50 and the second bayonet 52 can be closed as a result.

Primarily important draw-in-collet-side bayonet closure elements of the first bayonet closure 50 are, as shown in FIG. 3,—in this case—three circumferentially evenly distributed—locking stops 56, in the form of three transverse grooves 62, each of which is closed at its one end, has an undercut 64, and forms a stop.

Also provided as draw-in-collet-side bayonet closure elements of the first bayonet 50 are three longitudinal grooves 66 (correspondingly belonging to the three transverse grooves 62), which are evenly distributed over the outer circumference 48 of the draw-in collet 4,—are attached to the respective transverse groove 62 —, and start on that end face 90 of the draw-in collet 4 that faces away from the tool side.

These three longitudinal grooves 66—in the form of draw-in-collet-side bayonet closure elements of the first bayonet 50—also at the same time form draw-in-collet-side bayonet closure elements of the second bayonet 52.

Further draw-in-collet-side bayonet closure elements of the second bayonet closure 52, which—in a similar way to the transverse grooves 62 —“adjoin” the longitudinal grooves 66, are three “transverse grooves” respectively forming clamping shoulders 60—with corresponding clamping surfaces 68.

If, as is also shown in FIG. 3, these three transverse grooves are each open at their groove ends, the three transverse grooves form a peripheral annular groove 92 on the outer side 48 of the draw-in collet 4.

In this respect, the—circumferential—extent of the “common” longitudinal grooves 66 (of the first bayonet 50 and the second bayonet 52) is in each case slightly larger than clamping shoulders 58 on the coupling element 6 or on the tension sleeve 8, with the result that the clamping shoulders 58 of the coupling element 6 or of the tension sleeve 8 can be pushed into or through the longitudinal grooves 66 on the draw-in collet 4.

The clamping surfaces 68 of the clamping shoulders 60 of the draw-in collet 4 (as is also the case for the clamping surfaces/shoulders 68/58 of the coupling element 6 or the tension sleeve 8) lie in a plane perpendicularly in relation to a center axis 70 of the draw-in collet 4 (and the same goes for the center axis 70 of the coupling element 6 or the clamping device 2). As shown in particular in FIG. 2, such—draw-in-collet-side and coupling-element-side —clamping surfaces 68 or clamping shoulders 58/60 are braced in pairs, as will be described in more detail below.

Coupling Element

The complementary “mating elements,” which correspond to the draw-in-collet-side bayonet closure elements of the first bayonet 50 and the second bayonet 52, of the coupling element 6 or of the tension sleeve 8 are on the inner circumference 46 of the coupling element 6 or of the tension sleeve 8, as can be seen in FIGS. 1 and 2.

Here, FIGS. 1 and 2 depict that these “mating elements”, which correspond to the draw-in-collet-side bayonet closure elements of the first bayonet 50 and the second bayonet 52, are located on the tool-side end, on the inside 46 of the coupling element 6 or of the tension sleeve 8.

Essential coupling-element-side bayonet closure elements of the first bayonet 50 are three radially 86 inwardly protruding locking pins 54, which are distributed evenly over the inner circumference of the coupling element 6 or of the tension sleeve 8.

Three clamping shoulders 58—with corresponding clamping surfaces 68—in the form of coupling-element-side bayonet closure elements of the second bayonet closure 52 are located on the inner circumference 46 of the coupling element 6 or of the tension sleeve 8.

It is also the case that these clamping surfaces 68 on the clamping shoulders 58 of the coupling element 6 or of the tension sleeve 8 lie in a plane perpendicularly in relation to a center axis 70 of the coupling element 6 (and the same goes for the center axis 70 of the draw-in collet 4 or the clamping device 2).

While the coupling-element-side clamping surfaces 68 of the second bayonet 52 are located/formed on the respective clamping shoulder 58 so as to face away from the tool side, the complementary draw-in-collet-side clamping surfaces 68 of respective clamping shoulders 60 there are located on the respective clamping shoulder 60 so as to be on the tool side —, as a result of which the clamping shoulders 60/58 of draw-in collet 4 and coupling element 6 or tension sleeve 8—in each case can be braced in pairs over their respective clamping surfaces 68.

In this respect, the—circumferential—extent of the coupling-element-side clamping shoulders 58 is the same as that of the draw-in-collet-side clamping shoulders 60 (the same correspondingly also applies to the clamping surfaces 68), with the result that—mutually braceable—clamping shoulders 60/58 of draw-in collet 4 and coupling element 6 or tension sleeve 8 or their clamping surfaces 68—when the second bayonet 52 is closed—can completely overlap.

As also depicted in FIGS. 1 and 2, an internal thread 94, by means of which the coupling element 6 or the tension sleeve 8 can be screwed to the tension rod 32, is introduced at that end of the coupling element 6 or of the tension sleeve 8 that faces away from the tool side, likewise on the inside 46 of the coupling element 6 or of the tension sleeve 8.

To that end, as FIG. 2 in particular shows, a corresponding external thread 96 is applied to the outer circumference 48 of the tool-side end of the draw-in collet 4.

Clamping Mechanism for Bracing the Second Bayonet

The second bayonet 52 can be or is braced by means of a clamping mechanism 72—introduced between tension rod 32 and coupling element 6.

To that end, the tension rod 32, as FIG. 2 in particular shows,—at its tool-side end—provides a receiving opening 98, into which a (tension) spring 26 can be or is placed.

Within this receiving opening 98, the spring 26 is supported on a peripheral shoulder 100 in the receiving opening 98 of the tension rod 32. In the untensioned state, the spring 26—if it is placed in the receiving opening 98 and supported there against the shoulder 100—protrudes axially 80 beyond the tension rod 32 by approximately half of its (axial) length.

On the tool side of the spring 26 there is placed a pressing ring 28, which—if the coupling element 6 or tension sleeve 8 is screwed to the tension rod 32—dips into the through-opening 102 of the coupling element 6 or of the tension sleeve 8.

The pressing ring 28 can be supported on radial locking bolts 54 (cf. above in relation to the coupling element 6 or below in relation to the first bayonet 50) located on the inside 46 of the coupling element 6 (here, the draw-in collet has not yet been pushed into the coupling element 6 or tension sleeve 8), with the result that—if the coupling element 6 or tension sleeve 8 is screwed to the tension rod 32—the spring 26 is compressed and pretensioned.

The spring 26—via its pressing ring 28—can be further axially 80 tensioned by the through-opening 102 of the sleeve-shaped coupling element 6 or of the tension sleeve 8, as is the case when the bayonets 50, 52 are being closed or when the second bayonet 52 is being braced.

In this instance,—when the draw-in collet 4 is pushed into the coupling element 6,—that end face of the draw-in collet 4 that faces away from the tool side then presses onto the pressing ring 28—and displaces it, counter to the spring force, (further) axially 80 (, as a result of which the pressing ring 28 detaches from the locking pins 54).

This spring force—if the two bayonets 50, 52 are closed—has the effect that the second bayonet 52 is braced (here, the draw-in-collet-side and coupling-element-side clamping faces 68 of the clamping shoulders 60, 58 are each braced against one another in pairs by the spring force) but the first bayonet 50 is positioned free of axial 80 force in the process (here, the locking pins 54 are each “axially free” in the locking stops 56 or transverse grooves 62).

Tension Rod

As FIG. 2 in particular also shows, an elastic region 30—in the form of a corrugated-bellows-like region 30—is furthermore also formed on the tension rod 32—so as to face the tool side—directly behind the screwed-on coupling element 6 or tension sleeve 8.

If there is a force flow of a clamping/drawing-in force, that axially 80 draws in the draw-in collet 4, over this flexurally elastic region 30, this elastic region 30 can deform in such a way that the (axial) tensile forces (when a tool is being clamped) are distributed evenly over the clamping surfaces 68 or clamping shoulders 58, 60 (of the second bayonet 52)—and thus ensure that the draw-in collet 4 is drawn in in a self-centered manner.

Main Body

As is also further depicted in FIG. 1, the main body 10 provides a concentricity adjusting device 34.

To that end, the main body 10 is in two parts—with a “front” first sub-body 104 facing the tool/workpiece and an adjacent second sub-body 106.

The first sub-body 104 is placed on an attachment flange 108 of the second sub-body 106—and can be radially 86 positioned by means of concentricity adjusting screws 36.

As can be seen furthermore also in particular in FIG. 2, the main body 10 may provide a radially inwardly protruding—in this case segmentally peripherally interrupted—shoulder 116 that serves as a stop. A (stop) shoulder 114 is located on the draw-in collet 4—in a correspondingly complementary manner.

When the draw-in collet 4 is drawn into the main body 10, the two shoulders 114/116 can abut one another. That is to say, the maximum extent to which axial drawing-in of the draw-in collet 4 can occur is delimited, this delimitation being able to prevent damage to the draw-in collet 4 in particular if it is drawn into the main body 10 empty (i.e. without a tool/workpiece).

Insertion of the Draw-In Collet and Actuation of the Bayonet

If—by way of example—a new draw-in collet 4 is to be inserted into the clamping device 2 (i.e., the old draw-in collet 4 has been removed from the clamping device 2 beforehand), this is done as depicted by the arrows P1, P2 and P3 in FIG. 1, as follows.

When inserting the draw-in collet 4 into the main body 10, the draw-in collet 4 is axially displaced relative to the coupling element 6 or tension sleeve 8, or pushed into the coupling element 6 or tension sleeve 8, by applying an external force (for example by means of the mounted insertion aid (which is not shown)) counter to the spring force of the clamping mechanism 72 (see above) (cf. P1 in FIG. 1).

Here, at the same time the coupling-element-side clamping shoulders 58 of the second bayonet 52 and the coupling-element-side locking pins 54 of the second bayonet 52 are pushed through or into the draw-in-collet-side common longitudinal grooves 66 (belonging to the first bayonet 50 and the second bayonet 52).

Axially pushing the draw-in collet 4 into the coupling element 6 or tension sleeve 8—into a predefined position—is delimited by an outer shoulder 110 on the draw-in collet 4, against which the clamping shoulders 58 of the coupling element 6 or of the tension sleeve 8 can be placed by way of their tool-side boundary surfaces 112.

If the draw-in collet 4, under the external force (insertion aid), is then rotated by approximately 60° relative to the coupling element (cf. P2 in FIG. 1), the locking pins 54 of the first bayonet 50—pushed over the undercuts 64—come into the stops of the transverse grooves 62 of the first bayonet 50.

At the same time the—draw-in-collet-side and coupling-element-side —clamping shoulders 60, 58 or their clamping surfaces 68 of the second bayonet 52 completely overlap (in pairs)—but still without the clamping shoulders 60, 58 or the clamping surfaces 68 of the second bayonet 52 being placed against one another.

Then, the external force on the draw-in collet 4 is withdrawn (, with the spring force of the clamping mechanism 72 then axially 80 displacing the draw-in collet 4) (cf. P3 in FIG. 1), with the result that the first bayonet 50 is locked, by virtue of the fact that the locking pins 54 of the first bayonet 50 enter the undercuts 64—and (, as a result of the spring force of the clamping mechanism 72,) the second bayonet 52 is braced, in that the clamping shoulders 58, 60 of the second bayonet 52 or their clamping shoulders 68 come into abutment —under compressive loading caused by the clamping mechanism 72.

If the clamping device 2 is then in the state in which the first bayonet 50 is locked and the second bayonet 52 is braced, the first bayonet 50 is free of axial force and the second bayonet 52 is under pretension.

Although the invention has been illustrated and described in more detail by the preferred exemplary embodiments, the invention is not restricted by the examples disclosed and other variations can be derived therefrom, without departing from the scope of protection of the invention.

The following is a summary list of reference numerals and the corresponding structure used in the above description of the invention:
2 Clamping device
4 Draw-in collet
6 Coupling element, tension sleeve
8 Tension sleeve
10 Main body, clamping body
12 (hydraulic/pneumatic/electromechanical) (continuously adjustable) clamping/drawing-in system
14 Inner cone, conical receiving opening/bore
16 Outer cone, outer casing
18 Cone angle
20 Slot
22 Spreading element, elastomer filling
24 Bore
26 Spring, spring loaded
28 Pressing ring
30 Flexurally elastic region, (corrugated—) bellows-like region
32 Tension rod
34 Concentricity adjusting device
36 Concentricity adjusting screw
38 Widening distance
40 Receiving region
42 (Corrugated) bellows, (corrugated—) bellows-like
46 On the inside, inner circumference
48 On the outside, outer circumference
50 First bayonet closure (locking means)
52 Second bayonet closure (bracing means)
54 Coupling-element-side bayonet closure element of the first bayonet closure, locking element, latching pin
56 Draw-in-collet-side bayonet closure element of the first bayonet closure, locking stop, end stop
58 Coupling-element-side bayonet closure element of the second bayonet closure, clamping shoulder
60 Draw-in-collet-side bayonet closure element of the second bayonet closure, clamping shoulder
62 Transverse groove
64 Undercut
66 Longitudinal groove (common draw-in-collet-side bayonet closure element)
68 Clamping surface
70 Center axis
72 Clamping mechanism
80 Axial, axial direction
84 (Cylindrical) inner casing, receiving opening
86 Radial, radial direction
88 Tongue
90 End face/edge
92 Annular groove
94 Internal thread
96 External thread
98 Receiving opening (for spring 26)
100 (Peripheral) shoulder
102 Inner through-opening of the coupling element 6
104 First sub-body
106 Second sub-body
108 Attachment flange
110 (Outer) shoulder
112 Boundary surface
114 (Stop) shoulder
116 (Stop) shoulder
P1, P2, P3 Arrows

1. A clamping device for a tool or workpiece, the clamping device comprising:
a draw-in collet and a coupling element;
a first bayonet closure and a second bayonet closure for locking and bracing said draw-in collet against said coupling element;
said first and second bayonet closures being configured to be brought into engagement at the same time, with said draw-in collet being locked against said coupling element by way of said first bayonet closure, and said draw-in collet being braced against said coupling element by way of said second bayonet closure.

2. The clamping device according to claim 1, wherein said coupling element is a tension sleeve, a tension sleeve secured to a tension rod, formed in one piece with a tension rod, or is a tension rod.

3. The clamping device according to claim 1, further comprising a clamping system, being a hydraulically actuated, pneumatically actuated, or electromechanically actuated clamping system, configured to continuously adjust a force and configured to axially displace said draw-in collet via said coupling element and/or via a tension rod to be screwed to said coupling element.

4. The clamping device according to claim 1, which comprises a main body formed with an inner cone in which said draw-in collet, having an outer cone, is received, and said main body having a concentricity adjusting device.

5. The clamping device according to claim 4, wherein a cone angle of said inner cone and said outer cone lies between 2° and 3°.

6. The clamping device according to claim 4, wherein said draw-in collet is formed with slots and spreading elements, which spread open said draw-in collet when said draw-in collet is detached, from a non-spread state, by a maximum radial widening distance of approximately 0.1 mm.

7. The clamping device according to claim 6, wherein the cone angle of said outer cone of said collet in the non-spread state corresponds to the cone angle of the inner cone of said main body, and/or a contour of said outer cone of said draw-in collet lies on an imaginary right circular cone.

8. The clamping device according to claim 6, wherein said spreading elements are elastomer fillings in said slots and/or in bores through which said slots pass.

9. The clamping device according to claim 1, wherein said second bayonet closure has mutually clampable, coupling-element-side and draw-in-collet-side clamping shoulders that are distributed evenly over a circumference of said coupling element and multiple clamping shoulders distributed evenly over a circumference of said draw-in collet.

10. The clamping device according to claim 9, wherein clamping surfaces to be placed against one another of mutually braceable clamping shoulders of said second bayonet closure lie in a plane perpendicularly to a center axis of said clamping device, with said clamping surfaces to be placed against one another of the mutually braceable clamping shoulders of said second bayonet closure being formed and located on said second bayonet closure such that, when said first bayonet closure is in a locked position, said clamping surfaces to be placed against one another substantially completely overlap.

11. The clamping device according to claim 1, further comprising a clamping mechanism, being a spring-loadable or spring-loaded pressing ring, configured to act on said draw-in collet.

12. The clamping device according to claim 1, wherein a force flow of a clamping force, which axially draws in the draw-in collet, is guided over a flexurally elastic region formed on another side of a receiving region for the tool or the workpiece of the draw-in collet downstream of said second bayonet closure, but in close vicinity of said second bayonet closure.

13. The clamping device according to claim 12, wherein said flexurally elastic region comprises a bellows and/or said flexurally elastic region is formed in a tension rod.

14. A draw-in collet for a clamping device for a tool or workpiece, the clamping device having a draw-in collet and a coupling element, the draw-in collet comprising:
a draw-in-collet-side bayonet closure element of a first bayonet closure and a draw-in-collet-side bayonet closure element of a second bayonet closure;
said draw-in-collet-side bayonet closure element of the first bayonet closure being a locking stop and said draw-in-collet-side bayonet closure element of the second bayonet closure being a draw-in-collet-side, force-transferring clamping shoulder to be braced against a coupling-element-side, force-transferring clamping shoulder of the coupling element.

15. The draw-in collet according to claim 14, which comprises spreading elements and slots, said spreading elements spreading open the draw-in collet when the draw-in collet is detached, from a non-spread state, by a maximum radial widening distance of approximately 0.1 mm.

16. The draw-in collet according to claim 15, wherein said spreading elements are elastomer fillings in said slots and/or in bores through which said slots pass.

17. The draw-in collet according to claim 14, wherein the second bayonet closure is formed, on the draw-in-collet side, a plurality of draw-in-collet-side, force-transferring clamping shoulders that are evenly distributed over a circumference and formed to be braced against coupling-element-side, force-transferring clamping shoulders, or clamping surfaces of said clamping shoulders lying in a plane perpendicularly with respect to a center axis of the draw-in collet.

18. The draw-in collet according to claim 14, formed with at least one longitudinal groove forming a common draw-in-collet-side bayonet closure element of the first bayonet closure and the second bayonet closure.

19. The draw-in collet according to claim 14, wherein said locking stop is an end stop of a transverse groove, the transverse groove having an undercut.

20. The draw-in collet according to claim 14, which comprises an outer cone to be received in an inner cone of a main body of the draw-in collet.

21. The draw-in collet according to claim 20, wherein said outer cone has a cone angle between 2° and 3°.

22. The draw-in collet according to claim 14, formed with a cylindrical receiving opening for receiving a tool or workpiece to be clamped, the tool or workpiece being cylindrical or having a cylindrical shank.

23. The draw-in collet according to claim 14, wherein said draw-in-collet-side bayonet closure elements of at least one of said first bayonet closure or said second bayonet closure are located on an internal circumferential surface of the draw-in collet or on an external circumferential surface of the draw-in collet.

24. A coupling element for a clamping device for a tool or workpiece, the clamping device having a draw-in collet and a coupling element, the coupling element comprising:
a coupling-element-side bayonet closure element of a first bayonet closure and a coupling-element-side bayonet closure element of a second bayonet closure;
said coupling-element-side bayonet closure element of the first bayonet closure being a locking element and said coupling-element-side bayonet closure element of the second bayonet closure being a coupling-element-side, force-transferring clamping shoulder to be braced against a draw-in-collet-side, force-transferring clamping shoulder of the draw-in collet.

25. The coupling element according to claim 24, wherein:
the coupling element is a tension sleeve to be secured to a tension rod or formed in one piece with a tension rod, the tension sleeve having the coupling-element-side bayonet closure elements of at least one of the first bayonet closure or the second bayonet closure located on an inside of the tension sleeve; or
the coupling element is a tension rod with the coupling-element-side bayonet closure elements of at least one of the first bayonet closure or the second bayonet closure located on an outside of the tension rod.

26. The coupling element according to claim 24, wherein the second bayonet closure is formed with a plurality of coupling-element-side, force-transferring clamping shoulders that are evenly distributed over a circumference and configured to be braced against draw-in-collet-side, force-transferring clamping shoulders, and/or clamping surfaces of the clamping shoulder lie in a plane perpendicularly with respect to a center axis of the coupling element.

27. The coupling element according to claim 24, wherein the first bayonet closure, on the coupling-element side, has multiple locking elements distributed evenly over a circumference.

28. The coupling element according to claim 24, wherein said locking element is a latching pin.

29. A method for preparing a clamping device for a tool or workpiece, the method which comprises:
providing the clamping device according to claim 1 with a draw-in collet and a coupling element;
axially displacing the draw-in collet relative to said coupling element by applying an external force counter to an internal force, by pushing the draw-in collet into the coupling element with an external force being external to the draw-in collet, and at the same time partially actuating the first bayonet closure and the second bayonet closure;
subsequently rotating the draw-in collet, with an external force, relative to the coupling element into a predefined position at a stop in the first bayonet closure, wherein the first bayonet closure and the second bayonet closure are still partially actuated; and
subsequently withdrawing the draw-in collet with an external force to thereby lock the first bayonet closure and to brace the second bayonet closure.

30. The method according to claim 29, which comprises rotating the draw-in collet by approximately 60° relative to the coupling element.
